(19) United States
(12) Patent Application Publication
(10) Pub. No.: US 2020/0189553 A1
(43) Pub. Date: Jun. 18, 2020

(54) METHOD AND SYSTEM FOR MONITORING THE STATE OF A BRAKE OF AN AIRCRAFT

(71) Applicant: Lufthansa Technik AG, Hamburg (DE)

(72) Inventor: Stefan Spiesmacher, Mainz (DE)

(21) Appl. No.: 16/605,515

(22) PCT Filed: Apr. 18, 2018
(86) PCT No.: PCT/DE2018/100367

§ 371 Date: Oct. 16, 2019

(30) Foreign Application Priority Data
Apr. 19, 2017 (DE) 10 2017 206 593.1

(51) Int. Cl. B60T 17/22; F16D 66/02; B64C 25/42

(52) U.S. Cl. CPC B60T 17/221; F16D 2066/001; B64C 25/42; F16D 66/021

(57) ABSTRACT

A method monitors a condition of a mechanical brake of an aircraft. In the method, a temperature of the mechanical brake is measured at at least one point in time during a landing operation after commencement of a mechanical braking operation. The measured temperature is compared with a standard temperature determined for the mechanical brake, at the at least one point in time during the landing operation after commencement of the mechanical braking operation. A state of wear of the mechanical brake is then identified on the basis of the measured temperature having exceeded the standard temperature beyond a predefined measure.

### CROSS-REFERENCE TO PRIOR APPLICATIONS

This application is a U.S. National Phase Application under 35 U.S.C. § 371 of International Application No. PCT/DE2018/100367, filed on Apr. 18, 2018, and claims benefit to German Patent Application No. DE 10 2017 206 593.1, filed on Apr. 19, 2017. The International Application was published in German on Oct. 25, 2018, as WO 2018/192629 under PCT Article 21(2).

### FIELD

The invention relates to a method and system for monitoring the condition of a mechanical brake of an aircraft.

### BACKGROUND

Mechanical brakes of an aircraft often have brake disks made of carbon or carbon material. Carbon brake disks are not only subject to mechanical wear during operation, but, irrespective thereof, can be impaired in terms of their state and their functionality by oxidation. Such an oxidation is promoted, for instance, by runway deicer.

A customary visual check on the brake disks often identifies damage by oxidation only once the structural integrity of the disks is impaired.

### SUMMARY

An embodiment of the present invention provides a method that monitors a condition of a mechanical brake of an aircraft. In the method, a temperature of the mechanical brake is measured at at least one point in time during a landing operation after commencement of a mechanical braking operation. The measured temperature is compared with a standard temperature determined for the mechanical brake, at the at least one point in time during the landing operation after commencement of the mechanical braking operation. A state of wear of the mechanical brake is then identified on the basis of the measured temperature having exceeded the standard temperature beyond a predefined measure.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows in schematic representation a disk brake for an aircraft; and

FIG. 2 shows normalized temperature data for a landing; and

FIG. 3 shows normalized temperature data for a landing.

### DETAILED DESCRIPTION

Embodiments of the present invention provide a method and system which enable an efficient condition monitoring and an early identification also of oxidation damage.

A method according to an embodiment of the invention has in a first variant the following steps:
a. measurement of the temperature T of the brake at at least one point in time t₂ during a landing operation after commencement of a mechanical braking operation,
b. comparison of the measured temperature T with a standard temperature determined for the brake, at the at least one point in time t₂ during a landing operation after commencement of a mechanical braking operation,
c. identification of a state of wear of the brake on the basis of the measured temperature T having exceeded the standard temperature beyond a predefined measure.

In a second variant, the method according to an embodiment of the invention has the following steps:
a. measurement of the temperature T of the brake at at least two points in time t₁, t₂, wherein t₁ is a point in time during the landing operation before commencement of a mechanical braking operation and t₂ is a point in time during the landing operation after commencement of a mechanical braking operation,
b. determination of a rise in temperature ΔT,
c. identification of a state of wear of the brake on the basis of the rise in temperature ΔT having exceeded a standard rise in temperature beyond a predefined measure.

A mechanical brake converts kinetic energy into thermal energy by friction. Within the framework of the present invention, this preferably relates to a disk brake, the disks are preferably carbon disks.

The brakes can be used on aircraft of any type, preferably on winged aircraft which must land at specific minimum speeds.

According to an embodiment of the present invention, a measurement of the temperature T of the brake is made by a suitable sensor. This relates to the absolute temperature at one or more points in time during a landing operation and an accompanying mechanical braking operation. In a further variant of the invention, a temperature measurement can also be realized before commencement of the mechanical braking operation. The temperature measurement is made with one or more sensors, which detect(s) the temperature of the brake disks or the temperature of a component whose temperature sufficiently correlates with that of the brake disks.

The standard temperature or the standard rise in temperature is the temperature or temperature difference which prevails or is obtained at the particular point in time or over an appropriate period, usually at an intact brake of the aircraft. The determination of these values can be realized within the framework of the invention in a manner explained in greater detail below.

The identification of a wear state is made according to an embodiment of the invention either on the basis of the absolute measured temperature value or the rise in temperature. Both a customary mechanical wear of a brake and an integrity of carbon brake disks, which integrity is impaired, in particular, by oxidation, is manifested in that a higher temperature or a higher rise in temperature takes place during the braking operation after the landing.

The term “wear state” denotes within the framework of the invention both a mechanical wear caused by the actuation of the brake and a change in state as a result of oxidation, in particular of carbon brake disks. Particularly preferably, an embodiment of the present invention relates to the identification or establishment of the oxidation state, i.e. of an impairments, caused by oxidation, of the structural integrity, which cannot, or can only with difficulty, be established by customary checks, in particular visual checks.

Although an embodiment of the present invention can also be used to identify mechanical wear, for this purpose simpler methods will often be available, for instance known visual checks, thickness measurements or a sensory detection of the position of the actuators of the brake.

Below, within the context of the invention, reference is therefore also made to the oxidation state.

Surprisingly, from the temperature or rise in temperature as the single measurable variable, the state of wear, and, in particular, the oxidation state, is able to be sufficiently accurately derived. According to an embodiment of the present invention, it can thus be provided that only the temperature or the rise in temperature (over the course of time) is used to determine the oxidation state.

Embodiments of the present invention allow, in particular, also an identification of a critical mechanical condition of a brake, which condition is not manifested in a visible reduction of the thickness of a carbon brake disk, but in an oxidation-induced impairment of the structural integrity thereof. Such an oxidation is sometimes unidentifiable in a visual check, but can lead in a following braking operation to complete destruction of the disk with loss of its braking effect and with consequential damage resulting from its fragments.

Preferably, a monitoring of the temperature T is realized at short time intervals (preferably at time intervals of 5 s or less, further preferably at time intervals of 1 s or less) or fully continuously over a time interval t which allows the registration of a representative temperature profile of a brake over a part of a braking operation after a landing, the complete braking operation, or, if need be, additionally also a cooling phase after the braking operation.

This time interval t preferably begins with the touchdown of the aircraft upon landing and has a duration of 20 to 1,000 s, preferably 50 to 600 s, further preferably 100 to 200 s. For instance, a duration of 160 s can be provided.

An embodiment of the present invention is, in particular, suitable for identifying changes in state of the oxidation state of a brake over a lengthy period. For this purpose, it can be preferred that the standard temperature and/or the standard rise in temperature are determined by the creation of a preferably moving average of n landing operations, wherein n preferably lies between 10 and 50, further preferably 15 and 30. n can be, for instance, 20.

The creation of such a moving average allows, in particular, changes in the temperature or in the rise in temperature which are brought about by a change in the operating conditions of the aircraft (for instance high or low external temperatures, frequent landing operations in short-haul operation, or sufficiently long cooling pauses in medium and long-haul operation) to be equalized, and hence allows the significance of the measurements to be enhanced.

In this context, it is likewise preferred if the standard temperature and/or the standard rise in temperature are determined by comparing the values of several mechanical brakes of an aircraft. Such an averaging over several brakes makes it easier to distinguish between a change in condition of brake disks which is damaged, for instance, by oxidation and temperature changes resulting from changed operating conditions.

According to an embodiment of the present invention, it is particularly preferred if the temperature T and/or the rise in temperature ΔT are normalized, i.e. specific operating conditions during a landing are taken into account in order to convert the measured values to so-called normal values.

It is here particularly preferred that the normalization is realized using the kinetic energy of the aircraft at the point of touchdown, since this kinetic energy broadly defines the thermal load on the brakes. In order to determine the kinetic energy, the mass and speed of the aircraft at the point of touchdown are preferably measured and/or calculated. In this way, changes in the measurement values, which result, for instance, from a high landing mass of the aircraft in short-haul operation or from a high touchdown speed dictated, for instance, by the wind conditions, can be subtracted out. It is likewise possible in the normalization to take account of other influence factors, for instance the use of other deceleration means such as reverse thrust or high-lift devices and air brakes, the point of actuation of the mechanical brakes after touchdown, the chosen automatic braking deceleration, etc. All this helps to distinguish between changes in the measurement values which are induced by the change in operating conditions and changes which are actually attributable to the oxidation state of the brake.

An embodiment of the present invention also provides a system for implementing a method according to the invention. This system has:
a. at least one temperature sensor assigned to the brake,
b. a memory device for measured temperatures and/or temperature patterns,
c. a comparator for comparing the measured temperatures and/or temperature patterns with corresponding standard values.

In the memory device can also be stored, in addition to temperature and/or temperature patterns, further relevant data, for instance parameters which are necessary to calculate a normalization of the temperatures. These can be, for instance, landing mass and/or landing speed.

The system components memory device and comparator can be arranged, within the framework of the invention, spatially separate from the aircraft, for instance on the ground. In this case, a device for data communication with the aircraft is provided. Within the framework of the invention, the device for data communication can comprise a wireless communication, a wired communication (for instance while the aircraft parks at the gate), or a communication by data carrier. A communication by data carrier can have, for instance, a suitable memory means on board the aircraft, which memory means is brought manually to a ground-based memory device and entered there.

In particular, the system components memory device and comparator can according to the invention be assigned to several aircraft. According to and embodiment of the present invention, it can then be provided that a device for determining standard temperature and/or a standard rise in temperature is provided, which device operates by using a comparison of the values of several brakes of a plurality of aircraft of same or similar type.

Aspects of the present invention are explained below with reference to illustrative embodiments.

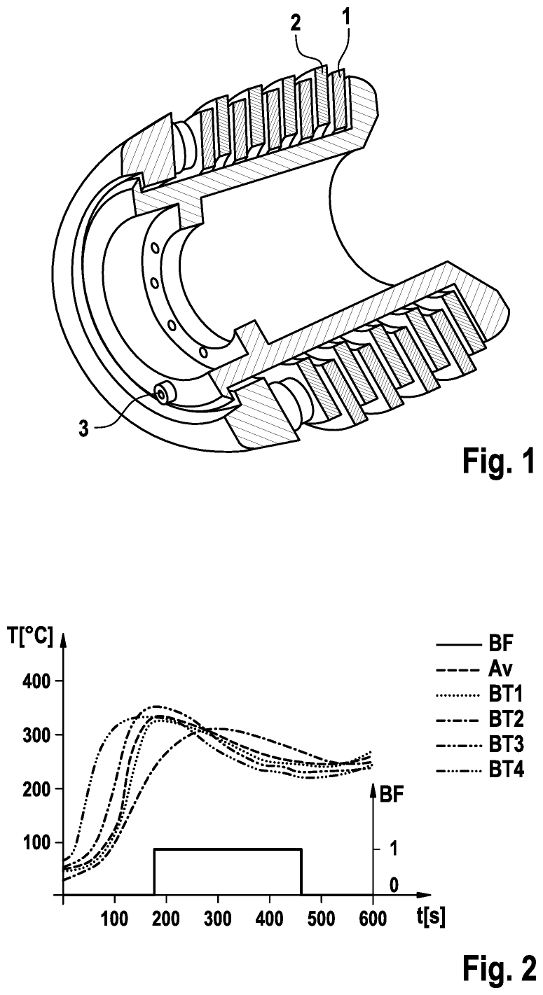

FIG. 1 shows in schematic representation a disk brake for an aircraft. The brake has five carbon stator disks 1 and four carbon rotor disks 2. The temperature is detected by a temperature sensor 3 and outputted as a voltage signal.

The method according to an embodiment of the present invention was implemented on Airbus A321 aircraft of Deutsche Lufthansa, which were used in intra-European short-haul traffic.

The maximum landing mass of an A321 is 75.5 t, the reference landing speed 73.6 m/s in the so-called full flap configuration. The kinetic energy at the point of touchdown for such a reference landing is around 204,000 kJ.

FIG. 2 shows, by way of example, normalized temperature data for a landing, which were recorded over a period of 900 s from the point of touchdown. The following measurement values are contained in the graphic:

BT1-BT4: temperatures of the four brakes
BF: brake fan on
Av: mean value of BT1-BT4
dL_{A}: deviation of the coldest brake from Av
dH_{A}: deviation of the hottest brake from Av.

It can be seen that the rise in temperature occurs in particular in the first 160 s after landing, after which, promoted by the switching-on of the fan, a cooling occurs. A slight rise occurs again at a later stage in the course of taxiing.

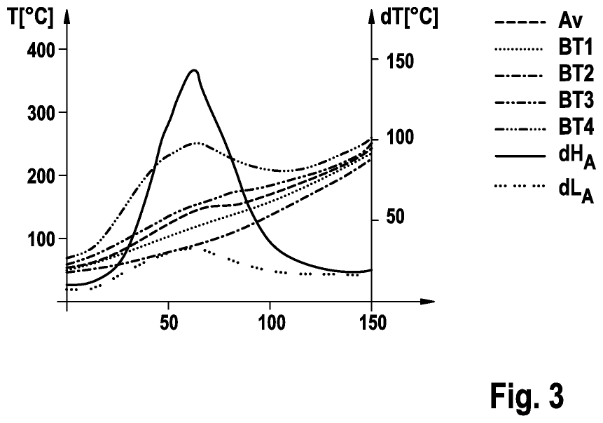

FIG. 3 shows normalized temperature data for a landing, which were recorded over a period of 150 s from the point of touchdown.

In this graphic, it can be seen that the temperature measured at brake 4 is at peak 140° C. higher than the average temperature of all four brakes. Within the framework of a method according to the invention, this is a clear indicator of a critical brake state due to oxidation.

17 days after this measurement, it was established in a routine inspection that this brake had failed. The measured (normalized) temperature deviation from the average was thus a reliable indicator of a critical condition of the brake due to oxidation.

In the retrospective viewing of the data of all landings of this period, the above-described behavior was observed frequently, but not in each landing. In order to display the permanently altered behavior of the particular brake, a moving average of the deviation from the average temperature over 30 landings was determined. This moving average was at a permanently high value, which indicated the problematic condition of the brake.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a condition of a mechanical brake of an aircraft, the method comprising:
a. measuring a temperature T of the mechanical brake at at least one point in time t₂ during a landing operation after commencement of a mechanical braking operation,
b. comparing the measured temperature T with a standard temperature determined for the mechanical brake, at the at least one point in time t₂ during the landing operation after commencement of the mechanical braking operation, and
c. identifying a state of wear of the mechanical brake on the basis of the measured temperature T having exceeded the standard temperature beyond a predefined measure.

2. A method for monitoring a condition of a mechanical brake of an aircraft, the method comprising:
a. measuring a temperature T of the mechanical brake at at least two points in time t₁, t₂, wherein a first point in time t₁ of the points in time is a point in time during a landing operation before commencement of a mechanical braking operation and the second point in time t₂ of the points in time is a point in time during the landing operation after commencement of the mechanical braking operation,
b. determining at least one rise in temperature ΔT₂, and
c. identifying a state of wear of the mechanical brake on the basis of the rise in temperature ΔT₂ having exceeded a standard rise in temperature beyond a predefined measure.

3. The method as claimed in claim 1, wherein a continuous measurement of the temperature T over a time interval t is realized.

4. The method as claimed in claim 3, wherein the time interval t begins with a touchdown of the aircraft in the landing operation and has a duration of 20 to 1,000 seconds.

5. The method as claimed in claim 1, wherein the standard temperature is determined by creation of a moving average value from n landing operations, wherein n lies between 10 and 100.

6. The method as claimed in claim 1, wherein the standard temperature is determined by comparing values of several brakes of the aircraft.

7. The method as claimed in claim 1, wherein the temperature T is normalized.

8. The method as claimed in claim 7, wherein the normalization is realized using a kinetic energy of the aircraft at a point of touchdown.

9. The method as claimed in claim 8, wherein, in order to determine the kinetic energy, a mass and a speed of the aircraft at the point of touchdown are measured and/or calculated.

10. The method as claimed in claim 1, wherein the mechanical brake has brake disks made of carbon material.

11. A system for implementing the method as claimed in claim 1, wherein the system comprises:
a. at least one temperature sensor assigned to the mechanical brake,
b. a memory device for storing measured temperatures and/or temperature patterns,
c. a comparator for comparing the measured temperatures and/or temperature patterns with corresponding standard values.

12. The system as claimed in claim 11, wherein the system additionally comprises a data input for the registration of a speed and a mass of the aircraft.

13. The system as claimed in claim 11, wherein the memory device and/or the comparator are arranged spatially separate from the aircraft, and a device for data communication with the aircraft is provided.

14. The system as claimed in claim 11, wherein the system is configured to determine the standard temperature and/or a standard rise in temperature using a comparison of values of several brakes of a plurality of aircraft of a same or similar type.

15. The method as claimed in claim 2, wherein the standard rise in temperature is determined by comparing values of several brakes of the aircraft.

16. The method as claimed in claim 2, wherein the rise in temperature ΔT is normalized.

17. The method as claimed in claim 2, wherein the standard rise in temperature is determined by creation of a moving average value from n landing operations, wherein n lies between 10 and 100.
